(19) United States
(12) Patent Application Publication
(10) Pub. No.: US 2018/0359340 A1
(43) Pub. Date: Dec. 13, 2018

(54) METHOD AND SYSTEM FOR EXECUTING A FUNCTION FOR PROCESSING DATA USING A SERVER

(71) Applicant: CADENS MEDICAL IMAGING INC., Granby (CA)

(72) Inventor: Thomas Bernard Pascal VINCENT, Brossard (CA)

(73) Assignee: Cadens Medical Imaging Inc., Granby, QC (CA)

(21) Appl. No.: 15/778,984

(22) PCT Filed: Nov. 25, 2016
(86) PCT No.: PCT/IB2016/057139

§ 371 Date: May 24, 2018

Related U.S. Application Data
(60) Provisional application No. 62/260,392, filed on Nov. 27, 2015.

(51) Int. Cl. H04L 29/06; G06F 9/50; H04L 29/08

(52) U.S. Cl. CPC H04L 67/42; H04L 67/10; G06F 9/5083

(57) ABSTRACT

A method and a system are disclosed for executing a function using a server, providing at least one processing functionality for processing data, the method comprising receiving, at a client, function arguments using a shell function; providing the received arguments to a function located at the server; obtaining result data from an execution of the function using the received arguments and wherein the shell function comprises a declarative function with corresponding function parameters representative of function parameters of the function; further wherein the declarative function has a corresponding function name mapped to the function.

### CROSS-REFERENCE TO RELATED APPLICATION

The present patent application claims priority on U.S. Patent Application No. 62/260,392, filed on Nov. 27, 2015.

### FIELD

The invention relates to data processing. More precisely, the invention pertains to a method and a system for executing a function for processing data using a server.

### BACKGROUND

Designing software interface requires the composition of visual and temporal behavior into a Graphical User Interface (‘GUI’). As defined in Wikipedia (http://en.wikipedia.org/wiki/Graphical_user_interface and http://en.wikipedia.org/wiki/Graphical_user_interface_elements), this is an important part of software application programming in the area of human-computer interaction. Its goal is to enhance the efficiency and ease of use for the underlying logical design of a stored program, a design discipline known as usability.

The WIMP paradigm (“window, icon, menu, pointing device”) of interaction uses a virtual input device to control the position of a pointer, most often a mouse, and presents information organized in windows and represented with icons. Available commands are compiled together in menus, and actions are performed making gestures with the pointing device.

The resulting GUI layout is composed of panels containing control widgets (icon, menu, button), that initiate actions, and content widgets (2D image, 3D volume), also known as viewports and that provide interactive actions on a content. For example, medical applications usually contain a main control widget and multiple viewports, the later enabling the visual representation of data, such as but not limited to 3D organ and 2D slices of a 3D organ, also known as raw CT scanner images.

### Example of a Slider

A slider is in general a rectangle with a handle. The handle can be dragged along one axis. The slider notifies other object of an application about the handle position, so that relevant objects may dynamically change accordingly.

A minimal example of the prior-art is to consider a slider which position represents an image slice (2D) within an image stack (3D) for presentation to the operator. An illustration of the final example is shown in FIG. 1.

A prior-art application would define at least five (5) components: (1) a general container of the application, (2) an image container that displays 2D images, (3) an image stack manipulation process that extracts image slices, (4) a slider object and (5) a slider function. The core of this prior-art application, as mentioned, is to couple the slider position with the image stack in order to extract a 2D slice.

A clear example of a limitation of such prior-art systems and methods is the necessity to tailor the function that couples the slider position to the extraction of the 2D slice, to the specificities of the 3D image stack (i.e. linear stack of images, complex stack whereby a single image originates from multiple imaging modalities in different coordinates, etc.). Indeed, in client/server architectures, the client cannot pre-determine the entire set of behavior it should be able to evolve into if the client does not known a-priori know the servers on which it may connect, and more specifically the potential “slider coupling functions” on the servers.

In other words, even with the ability to dynamically update their GUI, client applications of prior-art methods cannot contextually update their GUI based on some data provided through a server without knowledge of the entire set of possible updates.

Now referring to FIG. 2, there is shown an exemplary code snippet which represents an implementation of a graphical user interface that presents a slider to an operator in the case where the implementation needs to be performed locally, that is at a client side.

It will be appreciated that ⅚ of the code is about managing the layout, while ⅙ is about managing the behavior of the slider, specifically what value should be associated to what slider position along the axis, to further relate said value to another object, in this case a text output field.

Consequently, it can be seen that the function updatePos( ) is tailored to the need of the final application (i.e. determining a number to be displayed to the operator through a text field).

In other words, a-priori information is required to define the behavior of the slider with respect to the component it is providing interactivity on.

In such prior-art situations, it is understood that the client cannot evolve to respond dynamically to the nature of the contextual information presented to the operator, specifically as the client would not be aware of the type of interactive behavior expected between an graphical element object, and the data it is coupled to.

Nonetheless, it is accepted in prior art systems that providing a set of functionalities directly within a viewport can provide efficient integration of graphical user interface elements, such as, but not limited to buttons, icons and menus. Specifically, it is recommended to transfer relevant actions of the control widget directly inside relevant content widget. Examples of such have been extensively designed using OpenGL such as the open source project presented in PUI: A Picoscopic User Interface, http://plib.sourceforge.net/pui/and associated publication in Oct. 18, 2000 http://plib.sourceforge.net/pui/BasicPUI.html, released publicly in 2000, that describes itself as “PUI's widget rendering is performed using OpenGL calls, it is well suited to the job of adding a few simple GUI elements to a game or other interactive program where the GUI is required to overlay (often transparently) some 3D rendering”.

Now referring to FIG. 3, there is shown a user interface of a software solution depicting buttons and icons within the viewport. Such contextual approach allows the user to directly understand what actions belong to the viewport and frees some space in the overall solution.

Consequently layouts where tools, representing call for actions, are displayed within the viewport, even contextually, that is adapting to the content state, have been integrated into different software interfaces applied to a broad range of applications in prior art, such as web and mobile applications. Indeed mobile applications have extensively leveraged contextuality to display potential content's actions to the user as depicted below.

Finally, opening a specific set of tools for a given type of data, even a specific processing method, is currently extensively used throughout prior art. Examples of such are present in Windows system (http://en.wikipedia.org/wiki/Context-sensitive_user_interface, originally written in 2008), where “Clicking on a text document automatically opens the document in a word processing environment. The user does not have to specify what type of program opens the file under standard conditions. The user-interface may also provide Context sensitive feedback, such as changing the appearance of the mouse pointer or cursor, changing the menu color, or with applicable auditory or tactile feedback. At the simplest level each possible action is reduced to a single most likely action. The action performed is based on a single variable (such as file extension). In more complicated implementations multiple factors can be assessed such as the users previous actions, the size of the file, the programs in current use, metadata etc. The method is not only limited to the response to imperative button presses and mouse clicks—pop up menus can be pruned and/or altered, or a web search can prune results based on previous searches.” Further examples are presented in Intelligent context-sensitive interactions on desktop and the web, Alan Dix and al. 2006, http://www.hcibook.com/alan/papers/avi2006-context/.

As previously mentioned, context sensitivity is well known in the art, as demonstrated in The Human Controller: Usability and Accessibility in Video Game Interfaces, EitanM.Glinert, 2008 thesis Submitted to the Department of Computer Science and electrical engineering for the degree of Master, and already implemented from the game industry to the Google search engine and ads. Regarding gaming experience, as demonstrated in chapter 4 of The Human Controller: Usability and Accessibility in Video Game Interfaces, not only the user interface but the game engine itself is designed to contextually adapt to the user in order to provide a satisfactory experience.

Specific to the medical field, and as depicted in U.S. Patent Application No. 2013/0124459 (hereinafter '459) and U.S. Pat. No. 8,908,947 B2 (hereinafter '947), current state-of-the-art systems and methods address the needs to provide a single user interface for coherent end-user experiences, by a-priori pre-processing any given image data received server-side using pre-defined processing workflows, further allowing the end-user to select at least one of the pre-determined post-processed results. To that end, the reference '947 claims the selection of workflows to be pre-determined from “a set of icons based from patient ID and procedure ID”; specifically, pre-established workflows are disclosed in the reference '459 where “set of icons” represents “image processing tools” deriving from “predefined sequence of workflow stages associated with a particular type of medical diagnosis or process”.

Nonetheless, each of the above systems and methods have serious limitations pertaining to the architecture required to enable such end-user experience, contextual sensitive feedback, in client/server applications without a-priori on the end-users objectives with respect to the data presented through the content widget. This is even more so an issue if multiple servers may interact with a given client-side device to deliver end-users experience, albeit single or collaborative experiences.

There is therefore a need for a method and a system that will overcome at least one of the above-identified drawbacks.

Features of the invention will be apparent from review of the disclosure, drawings and description of the invention below.

### BRIEF SUMMARY

According to a broad aspect, there is disclosed a method for executing a function using a server, providing at least one processing functionality for processing data, the method comprising providing to a client a shell function from a remote processing unit, receiving, at the client, function arguments using the shell function; providing the received function arguments to a function located at the server; obtaining result data from an execution of the function using the received arguments at the server; providing the result data to the client and wherein the shell function comprises a declarative function with corresponding function parameters representative of function parameters of the function; further wherein the declarative function has a corresponding function name mapped to the function.

In accordance with an embodiment, the providing of a shell function to the client is performed in response to an event from a user.

In accordance with an embodiment, the shell function is generated automatically at the server.

In accordance with an embodiment, the remote processing unit comprises the server.

In accordance with an embodiment, the corresponding function name is equivalent to the function.

In accordance with an embodiment, the corresponding function name is different to the function, a shell manager is located at the server and the shell manager is adapted for mapping the corresponding function name to the function.

In accordance with an embodiment, the shell manager is further adapted for mapping a subset of the corresponding function parameters to function parameters.

In accordance with an embodiment, the event from the user is associated with the data to be processed.

In accordance with an embodiment, the shell manager is capable of relaying the given function arguments to a given function located on another server.

In accordance with an embodiment, the shell manager is capable of relaying corresponding function arguments and the corresponding function name to a given function located on another server.

In accordance with an embodiment, the function provides a plurality of processing functionalities and the server further comprises a queue manager for dispatching each of the processing functionality to a corresponding sub-function according to a criterion.

In accordance with an embodiment, at least one sub-function is located at a remote server.

In accordance with an embodiment, the criterion is selected from a group consisting of a priority associated with a given function, processing available at the server, resources available at the server, synchronizing sub-functions associated with a given function at the server, managing shell function arguments rate to load balance processing function execution at a server and at least one user defined criterion.

In accordance with an embodiment, the result data is provided to the client via the shell function.

In accordance with an embodiment, the function for processing data is used for providing at least one part of a graphical user interface.

In accordance with an embodiment, the function for processing data comprises a function associated with an implementation of a slider in the graphical user interface.

In accordance with a broad aspect, there is disclosed a method for executing a function using a server, providing at least one processing functionality for processing data, the method comprising receiving, at a client, function arguments using a shell function; providing the received arguments to a function located at the server; obtaining result data from an execution of the function using the received arguments; and wherein the shell function comprises a declarative function with corresponding function parameters representative of function parameters of the function; further wherein the declarative function has a corresponding function name mapped to the function.

In accordance with an embodiment, the corresponding function name is different to the function and a shell manager is located at the server; the shell manager adapted for mapping the corresponding function name to the function.

In accordance with an embodiment, the function provides a plurality of processing functionalities and the server comprises a queue manager for dispatching each of the processing functionality to a corresponding sub-function according to a criterion.

In accordance with an embodiment, the criterion is selected from a group consisting of a priority associated with a given function, processing available at the server, resources available at the server, synchronizing sub-functions associated with a given function at the server, managing shell function arguments rate to load balance processing function execution at a server and at least one user defined criterion.

In accordance with a broad aspect, there is disclosed a processing device for executing a function using a server, providing at least one processing functionality for processing data, the processing device comprising a central processing unit; a display device; a communication port; a memory unit comprising an application for executing a function using a server, providing at least one processing functionality for processing data, the application comprising instructions for receiving, at a client, function arguments using a shell function; instructions for providing the received arguments to a function located at the server; instructions for obtaining result data from an execution of the function using the received arguments; wherein the shell function comprises a declarative function with corresponding function parameters representative of function parameters of the function; further wherein the declarative function has a corresponding function name mapped to the function; and a data bus for interconnecting the central processing unit, the display device, the communication port and the memory unit.

In accordance with a broad aspect, there is disclosed a non-transitory computer-readable storage medium for storing computer-executable instructions which, when executed, cause a processing device to perform a method for executing a function using a server, providing at least one processing functionality for processing data, the method comprising receiving, at a client, function arguments using a shell function; providing the received arguments to a function located at the server; obtaining result data from an execution of the function using the received arguments; wherein the shell function comprises a declarative function with corresponding function parameters representative of function parameters of the function; further wherein the declarative function has a corresponding function name mapped to the function.

An advantage of the method disclosed is that it enables the execution of a function for processing data on a client using the resources from a processor of a server.

Another advantage of the method disclosed is that it improves the maintenance of a system comprising a plurality of clients and a server since the maintenance is mainly performed at a server side rather than at a client side.

Another advantage of the method disclosed is that it enables data specific processing at the server side and equivalent functionality providing at the client side.

Other advantages will become evident to the ordinary skilled in the art from the description provided hereunder.

### BRIEF DESCRIPTION OF THE DRAWINGS

In order that the invention may be readily understood, embodiments of the invention are illustrated by way of example in the accompanying drawings.

FIG. 1 is a diagram which shows an example of a slider in a graphical user interface using for displaying medical images.

FIG. 2 is an exemplary code snippet which represents an implementation of a graphical user interface that presents a slider to an operator in the case where the implementation needs to be performed locally.

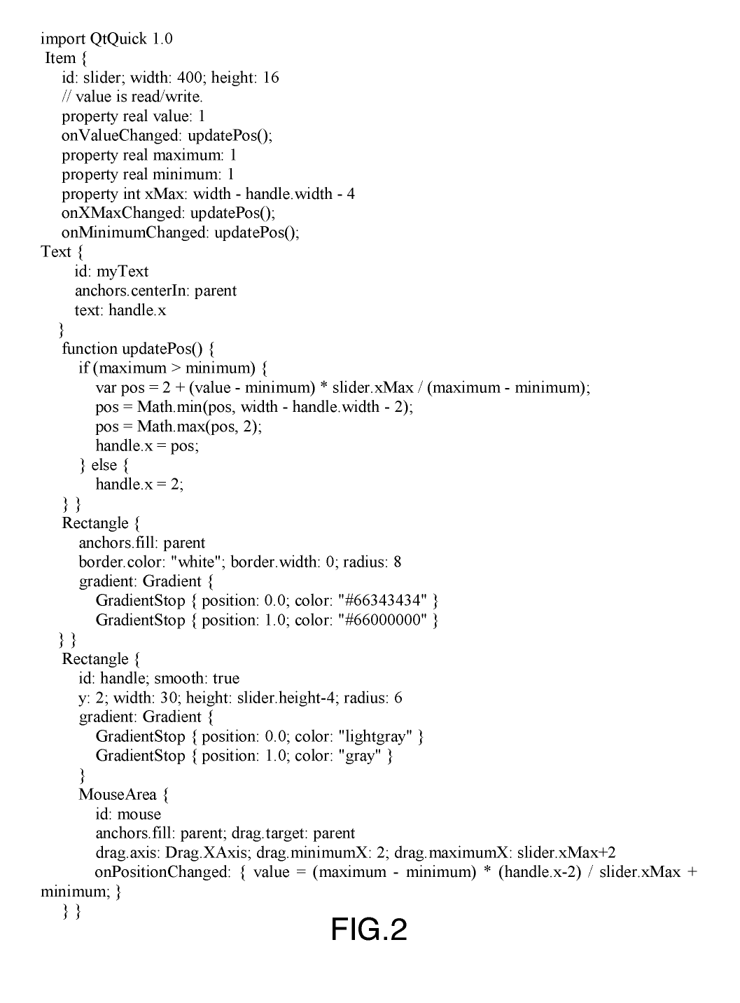

FIG. 3 is a diagram which shows a user interface of a software solution depicting buttons and icons within a viewport.

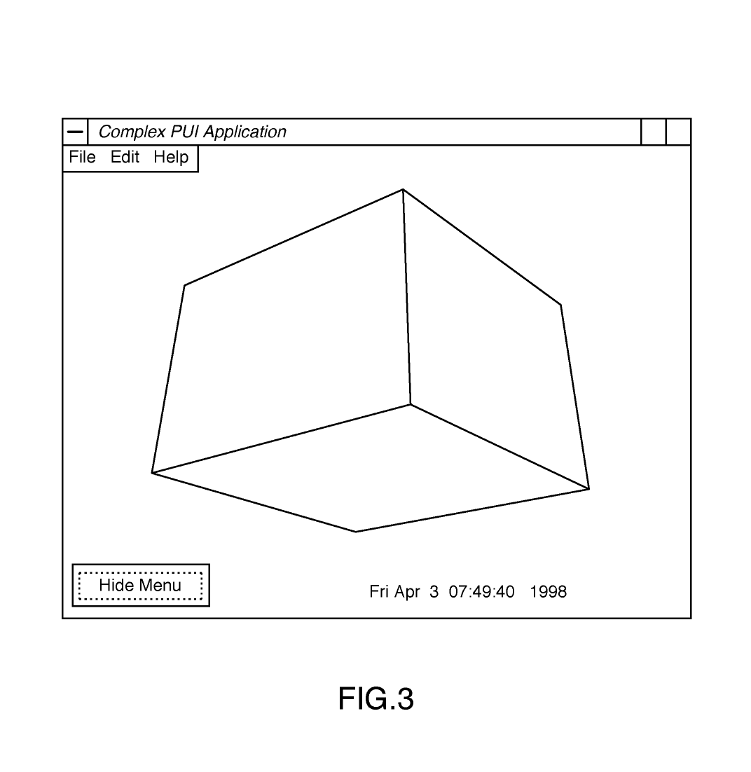

FIG. 4 is a flow chart which shows a first embodiment of a method for executing a function for processing data using a server.

FIG. 5 is a flow chart which shows a second embodiment of a method for executing a function for processing data using a server.

FIG. 6 is a block diagram which shows an embodiment in which a method for executing a function for processing data using a server may be implemented.

FIG. 7 is a block diagram which shows a first embodiment of the components located on a server side and on a client side and how they are used for executing a function for processing data using a server.

FIG. 8 is a block diagram which shows a second embodiment of the components located on a server side and on a client side and how they are used for executing a function for processing data using a server.

FIG. 9 is a block diagram which shows an embodiment of a processing device used for implementing a client.

FIG. 10 is an exemplary code snippet which represents an implementation of a graphical user interface in accordance with an embodiment of the invention.

Further details of the invention and its advantages will be apparent from the detailed description included below.

### DETAILED DESCRIPTION

In the following description of the embodiments, references to the accompanying drawings are by way of illustration of an example by which the invention may be practiced.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

The term “i.e.” and like terms mean “that is,” and thus limit the terms or phrases they explain.

The term “shell function” and like terms mean a declarative representation of at least one function to be executed at a server location, wherein said declarative representation of at least one function is empty from relevant processing functionality code, and has function parameters and function name relevant for the execution of the at least one function at a sever location. As it will become evident to the ordinary skilled in the art, execution of the at least one server function can be done directly when arguments and names of shell function and function are similar, and through a shell manager as presented thereafter if they differ yet remaining relevant to one another.

The term “function arguments” and like terms mean real values passed to (and received by) the function.

The term “function parameters” and like terms mean the names listed in the function definition.

The term “declarative function” and like terms mean a function defined in a programming language that describes what a program should do, not how it should do it.)

The term “processing functionality” and like terms mean a processing function source code that processes input function argument(s) to generate output function argument(s). A non-limitative example of a processing functionality is that of the “sliding transfer function” whereby a graphical user interface element being a slider provides axial coordinates to a “sliding processing functionality” that translates such axial coordinates into an image position in a volume of multiple images as conventionally accepted in medical images.

The term “data event request” means a user input, including gesture input and device input such as from a computer mouse or a touch screen, generated through a human interface device enabling a user to interact with a content such as a graphic user interface.

It is understood from the above definitions that a function parameter is the variable which is part of the method's signature (method declaration). An argument is an expression used when calling the method, i.e. invoking programmatically the method in which function arguments relates to the value of relevant function parameters.

For instance, in the following code:

```
void Foo(int i, float f)
{
    // Do things
}
void Bar( )
{
    int anInt = 1;
    Foo(anInt, 2.0);
}
```

i and f are the parameters, and anInt and 2.0 are the arguments.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

With all this in mind, the present invention is directed to a method and to a system for executing a function for processing data using a server.

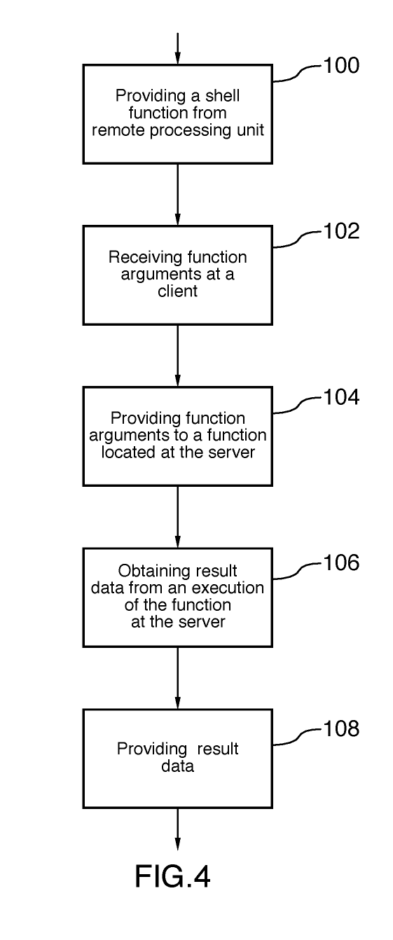

Now referring to FIG. 4, there is shown an embodiment of the method for executing a function for processing data using a server.

It will be appreciated that the function for processing data may be of various types.

For instance and in one embodiment, the function for processing data is related to the providing of a graphical user interface. In such case, the function may be a function associated with the implementation of a zoom on a graphical user interface in one embodiment. In another embodiment, the function is associated with the implementation of a slider in a graphical user interface.

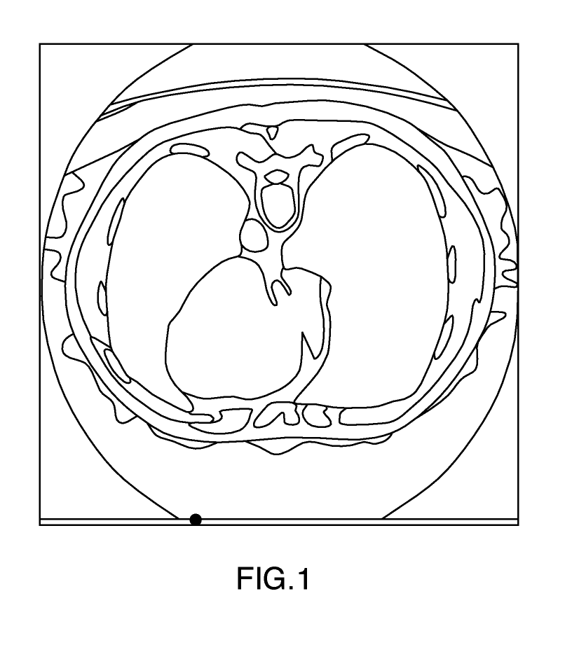

An example of a slider is shown at FIG. 1. In this embodiment, the slider is used in a graphical user interface for displaying medical images.

Depending on an interaction of a user with slider element, a given image within an image stack is displayed in the graphical user interface. The user can therefore navigate through the plurality of images using an interaction with the slider element.

It will be appreciated that the method disclosed herein is implemented in a client-server software architecture.

### Client/Server Environment

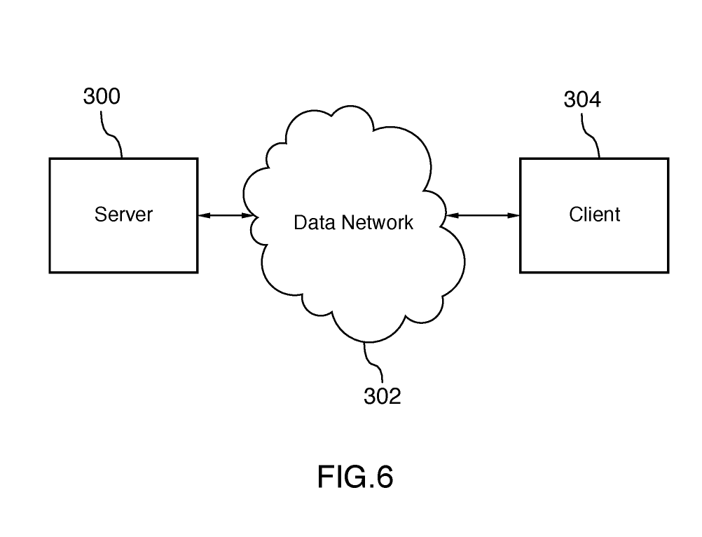

Such client-server software architecture is shown at FIG. 6. The client-server software architecture is made of client systems, also referred to as clients, and server systems, also referred to as servers.

For instance, in the embodiment disclosed in FIG. 6, the client systems comprise client 304. The server systems comprise server 300. The server 300 is operatively connected to the client 304 via a data network 302. While the embodiment shown in FIG. 6 shows a single client 304, it will be appreciated by the skilled addressee that more than one client may be provided.

Furthermore, it will be appreciated that the client 304 may be implemented on various types of processing devices.

In one embodiment, the client 304 is implemented in a processing device selected from a group consisting of smartphones, tablet computers, laptop computers, desktop computers, etc.

Similarly, it will be appreciated that the server 300 may be implemented on various types of processing devices.

In one embodiment, the server 300 is implemented on a processing device selected from a group consisting of laptop computers, desktop computers, workstations, virtual images of computers such as commercially available by VMWare etc.

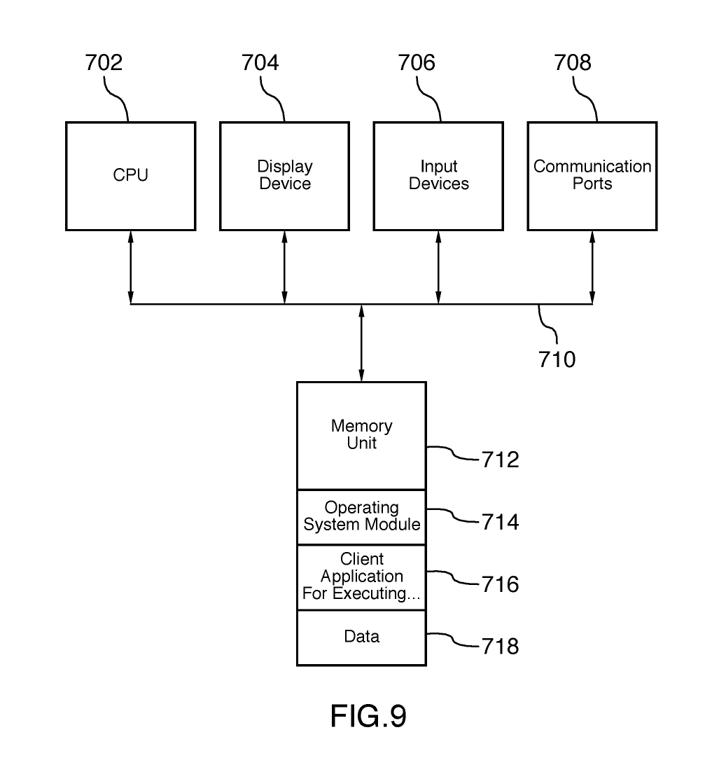

Now referring to FIG. 9, there is shown an embodiment of a processing device used for implementing the client 304.

In this embodiment, the processing device 700 comprises a central processing unit (CPU) 702, also referred to as a microprocessor, a display device 704, input devices 706, communication ports 708, a data bus 710 and a memory unit 712.

The CPU 702 is used for processing computer instructions. The skilled addressee will appreciate that various embodiments of the CPU 702 may be provided.

The display device 704 is used for displaying data to a user. The skilled addressee will appreciate that various types of display device may be used.

In one embodiment, the display device 704 is a standard liquid-crystal display (LCD) monitor.

The communication ports 708 are used for sharing data with the processing device 700.

The communication ports 708 may comprise for instance a universal serial bus (USB) port for connecting a keyboard and a mouse to the digital computer 202.

The communication ports 708 may further comprise a data network communication port such as an IEEE 802.3 (Ethernet) port for enabling a connection of the processing device 700 with another processing device, such as one implementing the server 300, via the data network 302.

The skilled addressee will appreciate that various alternative embodiments of the communication ports 708 may be provided.

In one embodiment, the communication ports 708 comprise an Ethernet port and a mouse port, e.g., Logitech™.

The memory unit 712 is used for storing computer executable instructions.

It will be appreciated that the memory unit 712 comprises in one embodiment an operating system module 714.

It will be appreciated by the skilled addressee that the operating system module 714 may be of various types.

Each of the CPU 702, the display device 704, the input devices 706, the communication ports 708 and the memory unit 712 is interconnected via the data bus 710.

The memory unit 712 further comprises a client application for executing a processing function for processing data using a server 716.

The memory unit 712 may further comprise data 718 used by the client application for executing a processing function for processing data using a server 716.

### Function Execution at a Client

In one embodiment, the client application for executing a processing function for processing data using a server 716 comprises instructions for receiving, at a client, function arguments using a shell function.

The client application for executing a processing function for processing data using a server 716 further comprises instructions for providing the received arguments to a function located at the server.

In one embodiment, a shell function representative of a function at a server is defined by having similar function name and similar function parameters.

In another embodiment, a shell function representative of a function at a server is defined such as the shell function communicates with a shell function manager at a server (thereafter referred to as a shell manager), wherein the shell manager uses the shell function name and shell function parameter to execute at least one relevant function at the server location, using at least one of the shell function arguments relevant to said at least one relevant function parameters.

The client application for executing a processing function for processing data using a server 716 further comprises instructions for obtaining result data from an execution of the function using the received arguments. It will be appreciated that the shell function comprises a declarative function with corresponding function parameters representative of function parameters of the function. It will be further appreciated that the declarative function has a corresponding function name mapped to the function.

It will be also appreciated that there is also disclosed a non-transitory computer-readable storage medium. The non-transitory computer-readable storage medium is used for storing computer-executable instructions which, when executed, cause a processing device to perform a method for executing a function using a server, providing at least one processing functionality for processing data, the method comprising receiving, at a client, function arguments using a shell function; providing the received arguments to a function located at the server; obtaining result data from an execution of the function using the received arguments; wherein the shell function comprises a declarative function with corresponding function parameters representative of function parameters of the function; further wherein the declarative function has a corresponding function name mapped to the function.

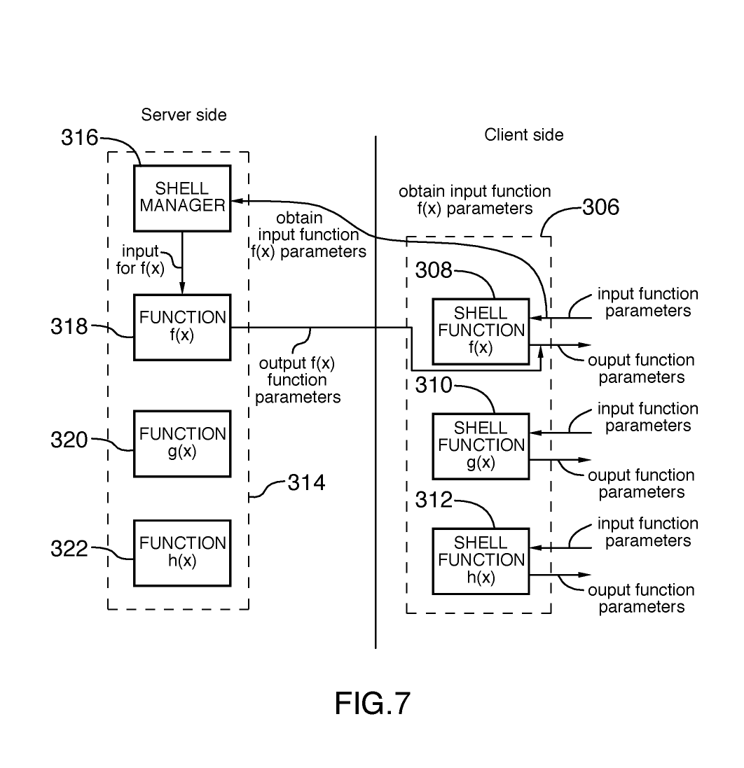

Now referring to FIG. 7, there is shown a first embodiment of the components located on a server side and on a client side and how they are used for executing a function for processing data using a server.

As shown in FIG. 7, at least one shell function 306 is located at the client side. In the embodiment disclosed in FIG. 7, the at least one shell function 306 comprises a first shell function f(x) 308, a second shell function g(x) 310 and a third shell function h(x) 312.

It will be appreciated that each shell function receives at least one corresponding input function parameters and provides at least one corresponding output function parameters.

Still referring to FIG. 7, it will be appreciated that the at least one function 314 is located at the server side.

In fact, it will be appreciated that each of the at least one function 314 is corresponding to a given shell function of the at least one shell function 306 on the client side.

More precisely, this means that each given shell function of the at least one shell function 306 has the same name than a corresponding given function of the at least one function 314. Moreover, each given function of the at least one function 314 has the same function parameters, in other words inputs and outputs, than a corresponding given shell function of the at least one shell function 306.

It will be therefore appreciated that the difference between a shell function and its corresponding processing functionality is that the shell function does not execute code related to the expected outcome. In fact, the shell function conveys relevant function arguments to the corresponding processing function residing at the server-side. The shell function has function parameters similar to the server-side function. In a different embodiment, the shell function transfers relevant function arguments to a shell manager residing server-side. The shell manager further dispatches relevant function arguments to relevant processing function

More precisely and in the embodiment disclosed in FIG. 7, the at least one function 314 comprises a first function f(x) 318, a second function g(x) 320 and a third function h(x) 322. Each of the first function f(x) 318, the second function g(x) 320 and the third function h(x) 322 is used for performing a given processing.

Since each of the at least one shell function 306 is representative of a given one of the at least one function 314, it will be appreciated by the skilled addressee that a function and its representative shell function have similar function parameters and function names.

### Providing a Shell Function

Now referring back to FIG. 4 and according to processing step 100, a shell function is provided to a client from a remote processing unit in a client-server software architecture.

In one embodiment, the remote processing unit comprises the server.

In one embodiment, the shell function is provided in response to an event from a user.

In one embodiment, the event is associated with the data to be processed.

In one embodiment, the shell function is provided by a server in response to an event from a user, wherein the event is associated with the data to be processed, and wherein the data to be processed is provided by the server along with the shell function.

In one embodiment, the shell function is generated automatically at the server.

In one embodiment, the event comprises an interaction of the user with a processing device acting as a client in the client-server software architecture.

According to processing step 102, function arguments are received at a client 304 using the shell function. It will be appreciated that the shell function has function parameters relevant to at least one function parameters residing server-side to execute a desired processing functionality.

It will be further appreciated that the function arguments are received at the client 304 using the shell function according to various embodiments.

In one embodiment, the function arguments are provided by another existing function.

For instance, the shell function f(x) 308 of the at least one shell function 306 receives the function arguments.

According to processing step 104, the received function arguments are provided to a function located at the server 300. The shell function is representative of the server function.

For instance, the function f(x) 318 of the at least one function 314 receives the function arguments.

In the embodiment shown in FIG. 7, the receiving of the function arguments of the function f(x) 318 is performed via a shell manager 316. More precisely, the shell manager 316 receives the function arguments of the shell functions 308 and provides the function arguments to the function f(x) 318.

The skilled addressee will appreciated that various alternative embodiments may be possible.

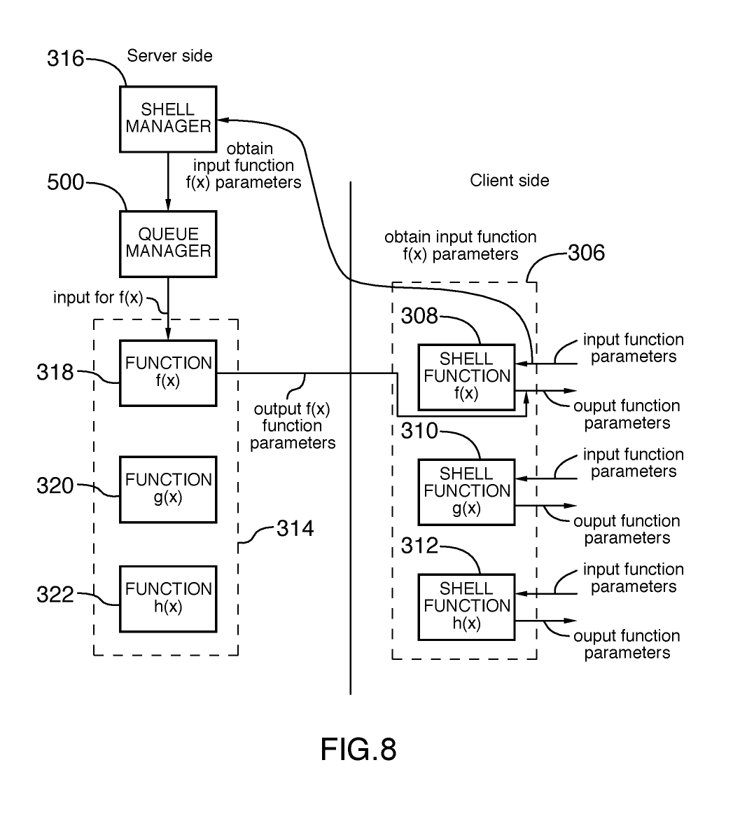

For instance and as shown in FIG. 8, a queue manager 500 may be used to provide the function arguments to a given function of the at least one function 314.

In fact, the function may provide a plurality of processing functionalities and the queue manager is used for dispatching each of the processing functionality to a corresponding sub-function according to a criterion.

The criterion may be selected from a group consisting of a priority associated with a given function, processing available at the server, resources available at the server, synchronizing sub-functions associated with a given function at the server, managing shell function arguments rate to load balance processing function execution at a server and at least one user defined criterion.

It will be further appreciated that in one embodiment at least one sub-function may be located at a remote server.

According to processing step 106, result data are obtained from an execution of the function using the received function arguments.

It will be appreciated that the result data from an execution of the function using the received function arguments are outputted by the function.

In another embodiment, it will be appreciated that the result data from an execution of the function using the received function arguments are outputted by at least one function different from the function, whereby the at least one different function is programmatically called and executed by the function.

In another embodiment, it will be appreciated that the result data from an execution of the function using the received function arguments are outputted by at least one function different from the function, whereby the at least one different function is programmatically called by the shell manager.

For instance, the function f(x) 318 provides an output.

According to processing step 108, the result data are provided.

The result data are provided by the function to the corresponding shell function.

For instance, the function f(x) 318 provides its output to the shell function f(x) 308.

It will be appreciated that the shell function comprises a declarative function with corresponding function parameters representative of function parameters of the function and the declarative function has a corresponding function name mapped to the function.

In one embodiment, the corresponding function name is equivalent to the function.

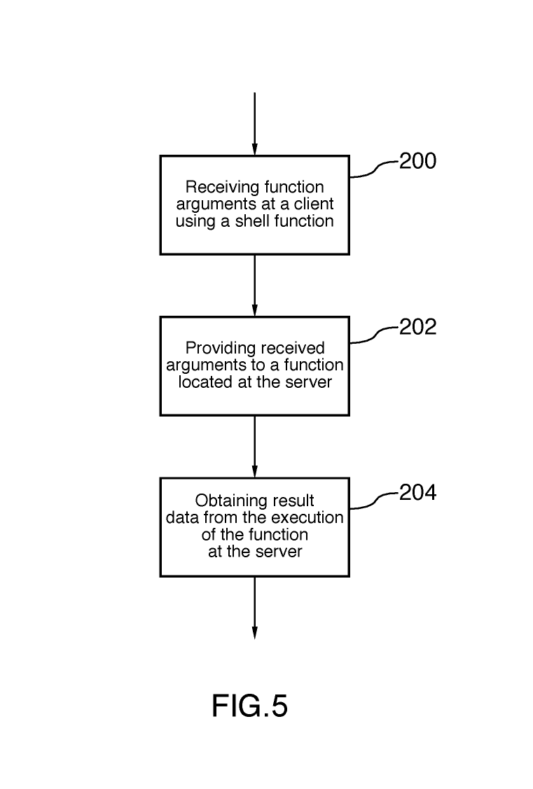

Now referring to FIG. 5, there is shown another embodiment of a method for executing a function for processing data using a server.

According to processing step 200, function arguments are received at a client using a shell function.

It will be appreciated that the function arguments are received at the client 304 using the shell function according to various embodiments.

In one embodiment, the function arguments are provided by another existing function

For instance, the shell function f(x) 308 of the at least one shell function 306 receives the function arguments.

According to processing step 202, the received arguments are provided to a function located at the server. It will be appreciated that the shell function is representative of the function.

In the embodiment shown in FIG. 7, the receiving of the function arguments of the function f(x) 318 is performed via a shell manager 316. More precisely, the shell manager 316 receives the function arguments of the shell functions 308 and provides the function arguments to the function f(x) 318.

The skilled addressee will appreciated that various alternative embodiments may be possible.

For instance and as shown in FIG. 8, a queue manager 500 may be used to provide the function arguments to a given function of the at least one function 314.

The providing of the function arguments by the queue manager 500 may be performed according to a criterion.

The criterion may be selected from a group consisting of a priority associated to a given function, processing power available at the server, resources available at the server, synchronizing sub-functions associated to a given function at a server, managing shell function arguments rate to load balance processing function execution at a server, a user defined criteria, etc.

According to processing step 204, the result data are obtained from the execution of the function using the received arguments. It will be appreciated that the result data comprise data associated to the shell function and data associated to the processing unit of the data providing the data associated to the shell function.

In one embodiment, a shell function is representative of a processing functionality corresponding to a slider position, wherein the slider position as output by the server function triggers the extraction and rendering of a single image from an image volume, and whereby the rendered image and slider position output are provided to the client application and the shell function respectively. In such embodiment, the rendered image is considered as data associated to the processing unit of the data providing the data associated to the shell function.

It will be understood that decoupling shell function arguments from the data associated to the processing unit of the data providing the data associated to the shell function arguments is of great advantage over prior art systems and methods.

In yet another embodiment, upon a client application requesting to access specific data information on a server, the server provides requested data alongside relevant at least one shell function and corresponding at least one shell function graphical user interface element to manipulate and examine said requested data, to the client.

It will be also appreciated by the skilled addressee that the present invention ensures processing function source code to be confidentially stored at a server, and never transmitted to the client, without impacting the final user experience deriving from a given shell function which is a great advantage over prior art systems and methods.

### Shell Manager

The shell manager enables going from a bijective representation of one server function to one shell function, to one shell function corresponding to multiple server functions, whereby the shell manager ensures function arguments and shell function arguments are compatible, and function names and shell function name are properly mapped by the shell manager to guarantee further communication from the at least one server function from multiple relevant servers functions to the shell function.

In one embodiment, the shell manager may dynamically relay shell function arguments to separately located servers throughout a network coupled to the client, based on a different criterion. The criterion may be selected for instance with an objective to load balance network bandwidth, to load balance different servers processing capacities, to optimize the topologic distance and response time between a server and a client, to overcome a single server point of failure or to relay shell function arguments to servers dedicated to specific client characteristics, e.g. mobile, tablets, computers, web-browsers, etc.

In one embodiment, the shell manager is adapted for mapping a subset of the corresponding function parameters to function parameters.

In another embodiment, the shell manager receives shell function arguments and determines the representative function to relay the shell function arguments to, based on pre-defined rules, by non-limiting example based on the required function processing time to complete as a trade-off with the information delay due to the network topology between said client and said server.

In another embodiment, the client graphical user interface is provided by a client device in a web-browser. The skilled addressee will appreciate that considering the fact that a shell function is empty from relevant processing code, the shell manager enables to dynamically change how user data may be processed by selecting which server function with compatible function arguments may be representative of the shell function, without typical web browser constraints such as, but not limited to, cross domain violation, cookie limitations and JavaScript engine browser specific security.

### Automatically Generating Shell Function

In one embodiment, at least one shell function is automatically generated at the server whereby the server uses local processing function header files, or any other declarative representation of methods, classes and functions representative of relevant processing functionality and sub-function necessary for relevant processing functionality, to automatically extract relevant processing function name and processing function parameters to generate declarative shell functions associated to said processing function.

### Application of the Method Disclosed to a Slider

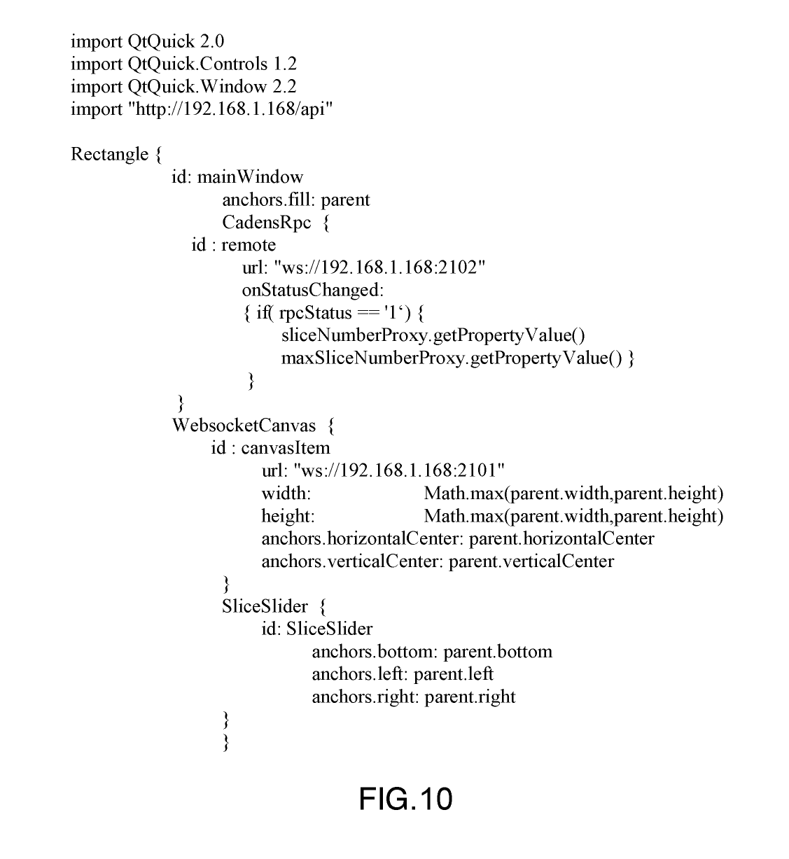

Now referring to FIG. 10, there is shown a code snippet which represents an implementation of a graphical user interface in accordance with an embodiment of the invention.

It will be appreciated by the skilled addressee that there are four (4) elements to this client.

A rectangle that is the container for the entire GUI, CadensRpc which is a communication link, enabling the SliceSldier to send and receive slider properties from the server (i.e. positions along an axis), and WebsocketCanvas which is the container for the image slice from the image stack to be presented to the operator, where the slice number is a function of the slider position whether linear or more complex depending on image size, nature and the stack volume.

It will be appreciated that in this embodiment, the SliceSlider is not programmatically directly coupled to the image stack, neither does it possesses the position function that relates the position of the slider to that of the image stack. Indeed, it is the server that has this knowledge, and processes input information received by the client SliceSlider.

Furthermore, Sliceslider is not a native Qt object. Consequently, the client does not have a knowledge of this object prior its connection to the server. Upon accessing and downloading the declarative shell functions accessible at the server, then the client dynamically instantiates this object and the graphical element of the slide is presented to the operator.

Although the above description relates to a specific preferred embodiment as presently contemplated by the inventor, it will be understood that the invention in its broad aspect includes functional equivalents of the elements described herein.

Clauses

Clause 1. A method for executing a function using a server, providing at least one processing functionality for processing data, the method comprising:

providing to a client a shell function from a remote processing unit,

receiving, at the client, function arguments using the shell function;

providing the received function arguments to a function located at the server;

obtaining result data from an execution of the function using the received arguments at the server;

providing the result data to the client;

wherein the shell function comprises a declarative function with corresponding function parameters representative of function parameters of the function; further wherein the declarative function has a corresponding function name mapped to the function.

Clause 2. The method as claimed in clause 1, wherein the providing of a shell function to the client is performed in response to an event from a user.
Clause 3. The method as claimed in clause 1, wherein the shell function is generated automatically at the server.
Clause 4. The method as claimed in any one of clauses 1 to 3, wherein the remote processing unit comprises the server.
Clause 5. The method as claimed in any one of clauses 1 to 4, wherein the corresponding function name is equivalent to the function.
Clause 6. The method as claimed in any one of clauses 1 to 4, wherein the corresponding function name is different to the function, further comprising a shell manager located at the server; the shell manager adapted for mapping the corresponding function name to the function.
Clause 7. The method as claimed in clause 6, wherein the shell manager is further adapted for mapping a subset of the corresponding function parameters to function parameters.
Clause 8. The method as claimed in clause 2, wherein the event from the user is associated with the data to be processed.
Clause 9. The method as claimed in clause 6, wherein the shell manager is capable of relaying the given function arguments to a given function located on another server.
Clause 10. The method as claimed in clause 6, wherein the shell manager is capable of relaying corresponding function arguments and the corresponding function name to a given function located on another server.
Clause 11. The method as claimed in any one of clauses 1 to 9, wherein the function provides a plurality of processing functionalities, further wherein the server comprises a queue manager for dispatching each of the processing functionality to a corresponding sub-function according to a criterion.
Clause 12. The method as claimed in clause 11, wherein at least one sub-function is located at a remote server.
Clause 13. The method as claimed in clause 11, wherein the criterion is selected from a group consisting of a priority associated with a given function, processing available at the server, resources available at the server, synchronizing sub-functions associated with a given function at the server, managing shell function arguments rate to load balance processing function execution at a server and at least one user defined criterion.
Clause 14. The method as claimed in any one of clauses 1 to 13, wherein the result data is provided to the client via the shell function.
Clause 15. The method as claimed in any one of clauses 1 to 14, wherein the function for processing data is used for providing at least one part of a graphical user interface.
Clause 16. The method as claimed in clause 15, wherein the function for processing data comprises a function associated with an implementation of a slider in the graphical user interface.
Clause 17. A method for executing a function using a server, providing at least one processing functionality for processing data, the method comprising:

receiving, at a client, function arguments using a shell function;

providing the received arguments to a function located at the server;

obtaining result data from an execution of the function using the received arguments; and

wherein the shell function comprises a declarative function with corresponding function parameters representative of function parameters of the function; further wherein the declarative function has a corresponding function name mapped to the function.

Clause 18. The method as claimed in clause 17, wherein the corresponding function name is different to the function, further comprising a shell manager located at the server; the shell manager adapted for mapping the corresponding function name to the function.
Clause 19. The method as claimed in clause 17, wherein the function provides a plurality of processing functionalities, further wherein the server comprises a queue manager for dispatching each of the processing functionality to a corresponding sub-function according to a criterion.
Clause 20. The method as claimed in clause 19, wherein the criterion is selected from a group consisting of a priority associated with a given function, processing available at the server, resources available at the server, synchronizing sub-functions associated with a given function at the server, managing shell function arguments rate to load balance processing function execution at a server and at least one user defined criterion.
Clause 21. A processing device for executing a function using a server, providing at least one processing functionality for processing data, the processing device comprising:

a central processing unit;

a display device;

a communication port;

a memory unit comprising an application for executing a function using a server, providing at least one processing functionality for processing data, the application comprising:
instructions for receiving, at a client, function arguments using a shell function;
instructions for providing the received arguments to a function located at the server;
instructions for obtaining result data from an execution of the function using the received arguments; wherein the shell function comprises a declarative function with corresponding function parameters representative of function parameters of the function; further wherein the declarative function has a corresponding function name mapped to the function; and

a data bus for interconnecting the central processing unit, the display device, the communication port and the memory unit.

Clause 22. A non-transitory computer-readable storage medium for storing computer-executable instructions which, when executed, cause a processing device to perform a method for executing a function using a server, providing at least one processing functionality for processing data, the method comprising:

receiving, at a client, function arguments using a shell function;

providing the received arguments to a function located at the server;

obtaining result data from an execution of the function using the received arguments;
wherein the shell function comprises a declarative function with corresponding function parameters representative of function parameters of the function; further wherein the declarative function has a corresponding function name mapped to the function.

1. A method for executing a function using a server, providing at least one processing functionality for processing data, the method comprising:
providing to a client a shell function from a remote processing unit,
receiving, at the client, function arguments using the shell function;
providing the received function arguments to a function located at the server;
obtaining result data from an execution of the function using the received arguments at the server;
providing the result data to the client;
wherein the shell function comprises a declarative function with corresponding function parameters representative of function parameters of the function; further wherein the declarative function has a corresponding function name mapped to the function.

2. The method as claimed in claim 1, wherein the providing of a shell function to the client is performed in response to an event from a user.

3. The method as claimed in claim 1, wherein the shell function is generated automatically at the server.

4. The method as claimed in claim 1, wherein the remote processing unit comprises the server.

5. The method as claimed in claim 1, wherein the corresponding function name is equivalent to the function.

6. The method as claimed in claim 1, wherein the corresponding function name is different to the function, further comprising a shell manager located at the server; the shell manager adapted for mapping the corresponding function name to the function.

7. The method as claimed in claim 6, wherein the shell manager is further adapted for mapping a subset of the corresponding function parameters to function parameters.

8. The method as claimed in claim 2, wherein the event from the user is associated with the data to be processed.

9. The method as claimed in claim 6, wherein the shell manager is capable of relaying the given function arguments to a given function located on another server.

10. The method as claimed in claim 6, wherein the shell manager is capable of relaying corresponding function arguments and the corresponding function name to a given function located on another server.

11. The method as claimed in claim 1, wherein the function provides a plurality of processing functionalities, further wherein the server comprises a queue manager for dispatching each of the processing functionality to a corresponding sub-function according to a criterion.

12. The method as claimed in claim 11, wherein at least one sub-function is located at a remote server.

13. The method as claimed in claim 11, wherein the criterion is selected from a group consisting of a priority associated with a given function, processing available at the server, resources available at the server, synchronizing sub-functions associated with a given function at the server, managing shell function arguments rate to load balance processing function execution at a server and at least one user defined criterion.

14. The method as claimed in claim 1, wherein the result data is provided to the client via the shell function.

15. The method as claimed in claim 1, wherein the function for processing data is used for providing at least one part of a graphical user interface.

16. The method as claimed in claim 15, wherein the function for processing data comprises a function associated with an implementation of a slider in the graphical user interface.

17. A method for executing a function using a server, providing at least one processing functionality for processing data, the method comprising:
receiving, at a client, function arguments using a shell function;
providing the received arguments to a function located at the server;
obtaining result data from an execution of the function using the received arguments; and
wherein the shell function comprises a declarative function with corresponding function parameters representative of function parameters of the function; further wherein the declarative function has a corresponding function name mapped to the function.

18. The method as claimed in claim 17, wherein the corresponding function name is different to the function, further comprising a shell manager located at the server; the shell manager adapted for mapping the corresponding function name to the function.

19. The method as claimed in claim 17, wherein the function provides a plurality of processing functionalities, further wherein the server comprises a queue manager for dispatching each of the processing functionality to a corresponding sub-function according to a criterion.

20. The method as claimed in claim 19, wherein the criterion is selected from a group consisting of a priority associated with a given function, processing available at the server, resources available at the server, synchronizing sub-functions associated with a given function at the server, managing shell function arguments rate to load balance processing function execution at a server and at least one user defined criterion.

21. A processing device for executing a function using a server, providing at least one processing functionality for processing data, the processing device comprising:
a central processing unit;
a display device;
a communication port;
a memory unit comprising an application for executing a function using a server, providing at least one processing functionality for processing data, the application comprising:
instructions for receiving, at a client, function arguments using a shell function;
instructions for providing the received arguments to a function located at the server;
instructions for obtaining result data from an execution of the function using the received arguments; wherein the shell function comprises a declarative function with corresponding function parameters representative of function parameters of the function; further wherein the declarative function has a corresponding function name mapped to the function; and
a data bus for interconnecting the central processing unit, the display device, the communication port and the memory unit.

22. A non-transitory computer-readable storage medium for storing computer-executable instructions which, when executed, cause a processing device to perform a method for executing a function using a server, providing at least one processing functionality for processing data, the method comprising:
receiving, at a client, function arguments using a shell function;
providing the received arguments to a function located at the server;
obtaining result data from an execution of the function using the received arguments;
wherein the shell function comprises a declarative function with corresponding function parameters representative of function parameters of the function; further wherein the declarative function has a corresponding function name mapped to the function.
